(19) United States
(12) Patent Application Publication
(10) Pub. No.: US 2008/0017687 A1
(43) Pub. Date: Jan. 24, 2008

(54) CAP BYPASS FEEDER

(76) Inventors: William C. Buck, Clemson, SC (US); Benjamin J. Thomas, Anderson, SC (US)

Correspondence Address: BRINKS HOFER GILSON & LIONE, P.O. BOX 10395, CHICAGO, IL, 60610, US

(21) Appl. No.: 11/683,180

(22) Filed: Mar. 7, 2007

Related U.S. Application Data
(60) Provisional application No. 60/832,255, filed on Jul. 20, 2006.

(51) Int. Cl. B27F 7/00

(52) U.S. Cl. 227/120

(57) ABSTRACT

A pneumatic nailing mechanism with a housing forming a handle with opposite ends and a longitudinal axis extending therebetween. A cap magazine extends from the housing and includes a track and a slot defined within the track. A latch member includes with a first portion extendable through the slot into an internal volume of the magazine and a second portion extending radially out of the cap magazine. A bracket is provided that is configured to ride within the track and the latch member is rotatably connected to the bracket along an axis perpendicular to the cap magazine axis against the biasing force of a spring.

### CROSS REFERENCE TO RELATED APPLICATIONS

This application claims priority to U.S. provisional application No. 60/832,255, which was filed on Jul. 20, 2006, and is hereby fully incorporated by reference herein. This application relates to U.S. utility application number ______, (attorney docket number 10710-1005 (PTG 1577 PUS)) titled “Cap Collation System,” which is filed on Mar. 7, 2007, the same day as the subject application, and additionally relates to U.S. utility application number ______, (attorney docket number 10710-1006 (PTG 1566 PUS)) titled “Cap Nailer and Feed System,” which is also filed Mar. 7, 2007, the same day as the subject application, both of which are fully incorporated by reference herein.

### BACKGROUND

Pneumatic nailers and staplers are frequently used in the construction industry and by amateur craftsmen to rapidly and precisely apply nails, or staples, or the like, to workpieces. For example, contractors often use pneumatic nailers or staplers to quickly install sheet-like material onto a substrate. Moreover, it may be desirable to fasten a sheet-like material such as roofing felt, sheathing, house wrap, or the like to the substrate. However, if the fastener directly attaches the sheet-like material to the substrate, the sheet-like material may be damaged or moisture may seep beneath the sheet material, thus damaging the substrate.

Pneumatic nailers or staplers are often used in conjunction with disks or caps between the head of the nail, or the crown of the staple, and the sheet-like material, such as a roofing shingle, foam board, or house wrap. If caps or disks are not used, roof shingles and the like, may tear away from the nail or staple because the compressive force on the workpiece is felt on a relatively small surface area on the workpiece. The use of caps or disks between the fastener head and the workpiece spreads the compressive force from the fastener to the larger surface area of the cap or disk to prevent the workpiece from tearing away from the fastener. Some local building codes require that caps be used with nails that are used in roofing and/or house wrap applications.

It is known to provide a pneumatic nailer or stapler that automatically feeds a cap beneath the driving portion of the tool such that a cap is automatically positioned between the fastener and the workpiece when the fastener is ejected from the tool. Current cap nailers that are known in the art often are constructed with a relatively large footprint at the work surface, which may prevent the tool from being used in tight spaces, such as inside corners, because the components used to store and feed the caps beneath the driving portion of the tool often extends significantly outward from the driving section. Additionally, the mechanism that inserts caps into the cap magazine that is provided with known pneumatic tools is cumbersome and requires many steps, which decreases the efficiency of the worker using conventional cap nailers or staplers. For example, cap nailers that are currently distributed by Bostitch and PneuTools each require five discrete steps to insert a stack of caps into the tool and a cap nailer sold by Central Fastener Co. requires eight discrete steps to insert a stack of caps into the tool. Each discrete step performed by the worker uses time that could be used for productive work with the tool, thereby reducing the worker's overall efficiency.

Finally, many current pneumatic nailers or staplers have complex mechanisms to provide a cap to the driving portion of the tool that use many moving parts. The complex design adds unneeded weight and cost to the tool, and increases the likelihood that the tool could become inoperative if one of the multiple parts becomes damaged.

Because a large number of caps are often used during single construction jobs, caps must be packaged in a way that is convenient to manufacture, ship, store, carry and install into a dispenser on the driver to allow the worker to operate the cap driver or stapler efficiently. This packaging may also be referred to as cap collation.

One way of collating the caps is by threading a retaining cord such as a mandrill or string through a hole in the center of each cap so that the caps are “stacked.” Once the caps are loaded into the dispenser, the retaining cord must be removed so that the caps may be dispensed. When the retaining cord is removed, the caps my have a tendency to flip, requiring that time be used rearranging the caps so that they do not jam the pneumatic driver. Caps also can come loose from the retaining cord as they are handled. Because loose caps have a tendency to flip over when they are loaded into the dispenser, they normally are discarded. Moreover, the retaining cord, upon its removal, also creates extra waste around a worksite.

Another way to collate the caps is via a coiled configuration. The caps are connected at their edges by flanges or the like into a side-by-side configuration and then coiled. However, the coil of caps often is bulky as compared to a stacked collation. Moreover, once loaded into the dispenser, the coil of caps additionally must be threaded into a feeding mechanism. If the threaded coil of caps tears, the coil may have to be removed, reloaded and/or rethreaded. Moreover, smaller portions of a coil may have to be discarded, thus wasting caps.

### BRIEF SUMMARY

In a first representative embodiment, a pneumatic nailing mechanism is provided that includes a housing with a handle with a first end and a second end and a longitudinal axis extending between the first and the second end. A nail driving mechanism is located at the first end of the handle for driving a nail from a nail magazine through a nailing axis that intersects the longitudinal axis of the handle. A cylindrical cap magazine is provided that includes a first end and a second end with a longitudinal axis through the center of the cap magazine. The cap magazine extends from the housing such that a first plane through both the cap magazine axis and the nailing axis forms an oblique angle with a second plane through the handle axis and the nailing axis. A movable shuttle is provided to translate a cap from the cap magazine to a position to receive a nail driven by the nail driving mechanism.

In a second representative embodiment, a pneumatic nailing mechanism is provided that includes a housing with a handle with a first end and a second end with a longitudinal axis extending between therebetween. A nail driving mechanism is provided at the first end of the handle for driving a nail from a nail magazine. A cylindrical cap magazine extends from the housing. The cap magazine includes a longitudinal axis through the center of the cap magazine and a track defining a slot, wherein the track and the slot extend parallel to the cap magazine axis from an open first end to the proximity of a second end. The cap magazine also includes a latch member with a first portion extendable through the slot into an internal volume of the cap magazine and a second portion extending radially out of the cap magazine. A bracket is provided and configured to ride within the track to allow the bracket to translate along the track. The latch member is rotatably connected to the bracket along an axis perpendicular to the cap magazine axis. The cap magazine also includes a coil spring with a first end fixed to one end of the cap magazine and a second end fixed to the bracket.

A third representative embodiment of a pneumatic nailing mechanism includes a housing with a handle with a first end and a second end and a longitudinal axis extending between the first and second ends. A nail driving mechanism is provided at the first end of the handle for driving a nail from a nail magazine through a nailing axis. The pneumatic nailing mechanism additionally includes a cylindrical cap magazine extending from the housing with a first end and an opposite second end. A movable shuttle is provided to translate a cap from the cap magazine to an operative position with the nail driving mechanism for receiving the nail driven by the nail driving mechanism. The shuttle includes a first end operatively connected with a reciprocating shaft within a piston, and an opposite second end translatable between a first position in the vicinity of the nail driving mechanism to a second position in the vicinity of the cap magazine based on the operation of the piston. The second end of the shuttle includes a circular aperture with the center of the aperture substantially in-line with the nailing axis when the shuttle is in the first position and the center of the aperture substantially in-line with the bottom end of the cap magazine when the shuttle is in the second position.

A collated stack of fastener caps is provided. The collated stack includes a proximal end and a distal end for use with a driver. The collated stack includes a plurality of fastener caps stacked atop each other, wherein each fastener cap includes an outer peripheral wall. A collating sheet extends between the proximal end and the distal end, wherein the collating sheet is attached to at least a portion of the outer peripheral wall of each of the plurality of fastener caps.

A method of collating and dispensing fastener caps to be used with a pneumatic fastener is provided. The method includes the steps of stacking a plurality of fastener caps one on top of the other to form a stack having a proximal end, a distal end, and an outer peripheral wall and attaching a retaining sheet to at least a portion of the outer peripheral wall from the proximal end to the distal end. The method further includes the steps of loading the stack into a magazine of a pneumatic fastener and shearing the retaining sheet just above the peripheral wall of the cap.

Advantages of the present disclosure will become more apparent to those skilled in the art from the following description of the preferred embodiments of the invention that have been shown and described by way of illustration. As will be realized, the disclosure is capable of other and different embodiments, and its details are capable of modification in various respects. Accordingly, the drawings and description are to be regarded as illustrative in nature and not as restrictive.

### BRIEF DESCRIPTION OF THE DRAWINGS

The features and advantages of the present disclosure may be better understood by reference to the accompanying drawings in which like reference numerals refer to like elements.

FIG. 1 is a perspective view of a cap nailer of a first representative embodiment.

FIG. 2 is a bottom view of the cap nailer of FIG. 1, showing the shuttle in alignment with the nailing axis.

FIG. 3 is the view of FIG. 2 with the shuttle shown in alignment with the cap magazine.

FIG. 4 is a partial bottom perspective view of the cap nailer of FIG. 1, showing the shuttle in alignment with the nailing axis.

FIG. 5 is a partial top perspective view of the cap nailer of FIG. 1, showing the shuttle in alignment with the cap magazine.

FIG. 6 is a bottom view of an alternate representative embodiment of a cap nailer, showing the shuttle in alignment with the nailing axis.

FIG. 7 is the bottom view of the cap nailer of FIG. 6, showing the shuttle in alignment with the cap magazine.

FIG. 8 is a bottom perspective view the cap nailer of FIG. 6, showing the shuttle in alignment with the nailing axis.

FIG. 9 is a right side view of the cap nailer of FIG. 6, showing the shuttle in alignment with the nailing axis.

FIG. 10 is the view of FIG. 9, showing the shuttle in alignment with the cap magazine.

FIG. 11 is a top view of the cap nailer of FIG. 1, showing an alternate embodiment of a cap magazine.

FIG. 12 is a side view of the cap magazine of FIG. 11, showing the latch in a first position.

FIG. 13 is the view of FIG. 12, showing the latch in a second position.

FIG. 14 is a front view of the cap nailer of FIG. 1.

FIG. 15 is a perspective view of the shuttle of FIG. 1.

FIG. 16 is a plan view of a fastening cap.

FIG. 17 is a perspective view of the fastening cap of FIG. 16.

FIG. 18 is a collated stack of fastening caps.

### DETAILED DESCRIPTION

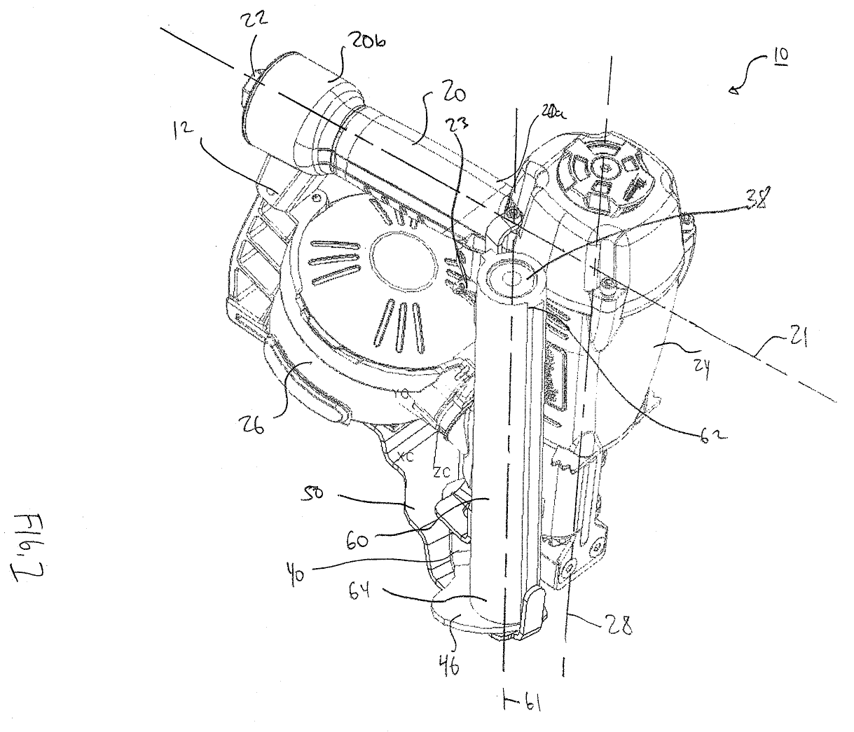

Turning now to FIGS. 1, 11, and 14, a first representative embodiment of a cap nailer/stapler 10 is provided. The cap nailer/stapler 10 includes a housing 12 that aligns and connects the remaining components of the cap nailer/stapler 10. The cap nailer/stapler 10 includes pneumatic power nailer 24 that operates to drive a nail, or similar fastener such as a staple or a brad, into a work surface (not shown). The power nailer 24 receives compressed air through an air inlet 22 that is connected to an air reservoir (not shown) or an air compressor (not shown) to provide a consistent and regulated source of compressed air. The power nailer 24 receives a supply of nails from a nail magazine 26, which is attached to the tool to provide a continuous supply of nails to the power nailer 24 during operation of the cap nailer/stapler 10. The power nailer 24 operates to propel nails with a large force along the longitudinal axis, or nail axis, 28 of the power nailer 24.

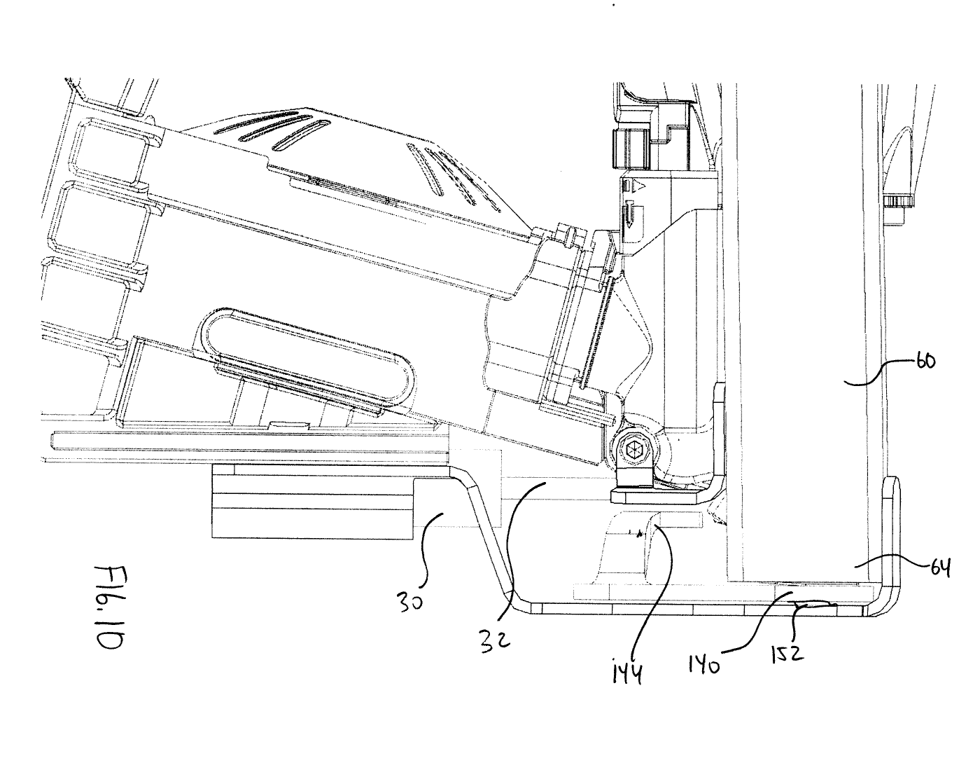

The cap nailer/stapler 10 additionally includes a handle 20 that forms a portion of the housing 12 and includes a first end 20a that is attached to the power nailer 24 and extends to a second, rear end, 20b along a longitudinal handle axis 21. A vertical plane B (best shown in FIG. 11 with the plane extending out of the page) may be formed parallel to the longitudinal axis 21 of the handle 20 and may extend through the nailing axis 28. The handle 20 provides an ergonomic surface for the user to easily and sturdily hold and operate the cap nailer. The handle 20 may be molded to be easily gripped and operated by a plurality of different hand sizes, as well by either a right or a left hand.

A space is provided between the handle 20 and the nail magazine 26 to provide space for the user's fingers to wrap around the handle 20. A trigger 23 is provided on the handle 20 to selectively operate the cap nailer/stapler 10 when the trigger 23 is compressed to drive a nail into a work surface. When the trigger 23 is compressed, a surge of compressed air flows to the power nailer 24, which causes the power nailer 24 to eject a nail along the nail axis 28, as is known in the art.

The cap nailer/stapler 10 additionally includes a cap magazine 60 and a shuttle 40 to translate a fastener cap 200 from a second end 64 of the cap magazine 60 to under the power nailer 24 such that the nail extends through the fastener cap 200 when ejected from the power nailer 24. Accordingly, when the nail is ejected from the power nailer 24, the tip of the nail extends through the fastener cap 200 that is positioned below the power nailer 24 by the shuttle 40. The fastener cap 200 has a relatively large surface area, causing the compressive force of the nail to act on the work surface across the surface area of the fastener cap 200, and not only the small surface area of the nail head. Accordingly, the fastener caps 200 allow the ejected nails to rigidly maintain the workpiece in the selected position. Fastener caps 200 are normally formed from durable, but slightly flexible, materials such as galvanized steel, stainless steel, or plastic, or any resilient metal suitable for exposure to inclement weather. In other embodiments, fastener caps 200 may be made from other materials such as tin.

The cap magazine 60 is formed as a substantially cylindrical hollow tube that includes open first and second ends 62, 64 and a longitudinal axis 61 that extends through the center of the cap magazine 60 therebetween. The cap magazine 60 may extend from housing 12 at an oblique angle with respect to the handle 20. Specifically, as shown in FIG. 11, a plane C (shown in FIG. 11 extending out of the page) that extends through the cap magazine axis 61 and through the nail axis 28 forms an oblique angle α with the plane B through the longitudinal axis 21 of the handle and the nail axis 28. In some embodiments, the angle α is an angle between about 30 degrees and about 60 degrees. In other embodiments, the angle α is between about 40 and about 50 degrees. In still other embodiments, the angle α is about 45 degrees.

Embodiments where the cap magazine 60 is oriented at an oblique angle to the handle 20, as discussed above, limits the horizontal distance that the cap magazine 60 extends from power nailer 24 (i.e. the projection perpendicular to the longitudinal axis of the tool), which limits the size of the footprint of the front end of the cap nailer/stapler 10. The reduced footprint allows the tool to be used in tighter interior corners than would be possible with conventional cap nailers that have a cap magazine that extends substantially perpendicular to the longitudinal axis of the tool.

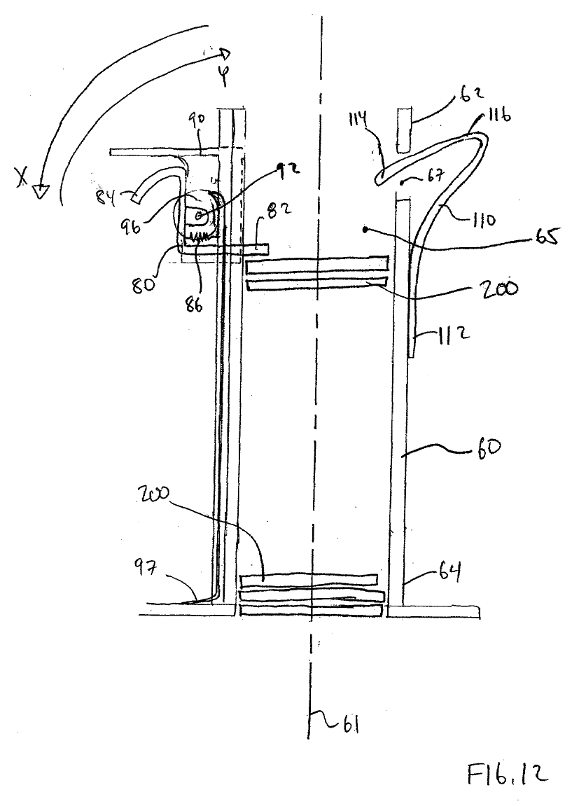

The cap magazine 60 may extend from the housing 12 at an oblique angle with the power nailer 24. Specifically, as shown in FIG. 14, the cap magazine 60 extends from the power nailer 24 such that the longitudinal axis 61 of the cap magazine 60 forms an acute angle β with respect to the nail axis 28. In some embodiments, the angle β may be between about 5 and about 30 degrees. In other embodiments, the angle β may be between about 10 and 20 degrees. In still other embodiments, the angle β may be about 15 degrees. In other embodiments, the cap magazine 60 may be connected to the housing 12 such that the cap magazine axis 61 and the nail axis 28 are substantially parallel. In still other embodiments, the cap magazine may be connected to the housing 12 such that the longitudinal axis 61 of the cap magazine 60 and the nailing axis 28 are substantially perpendicular.

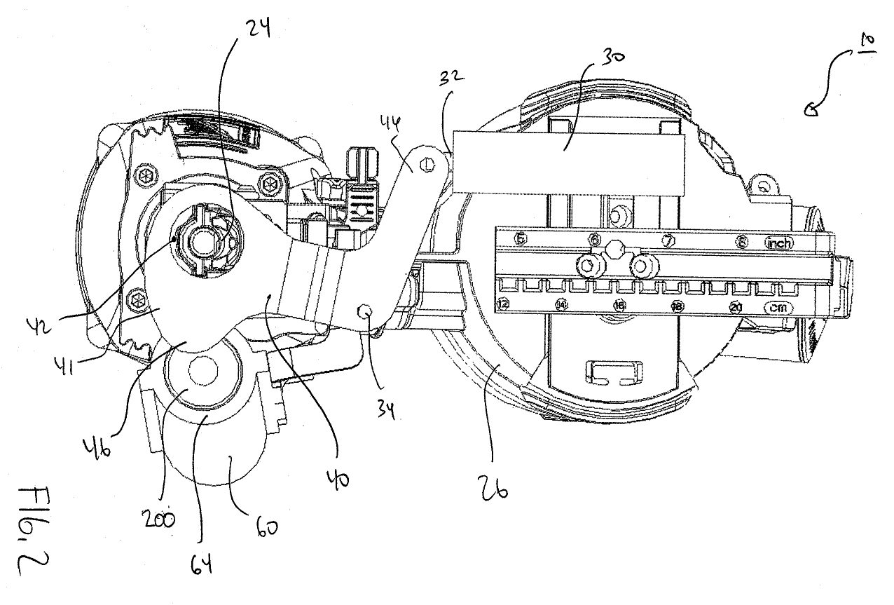

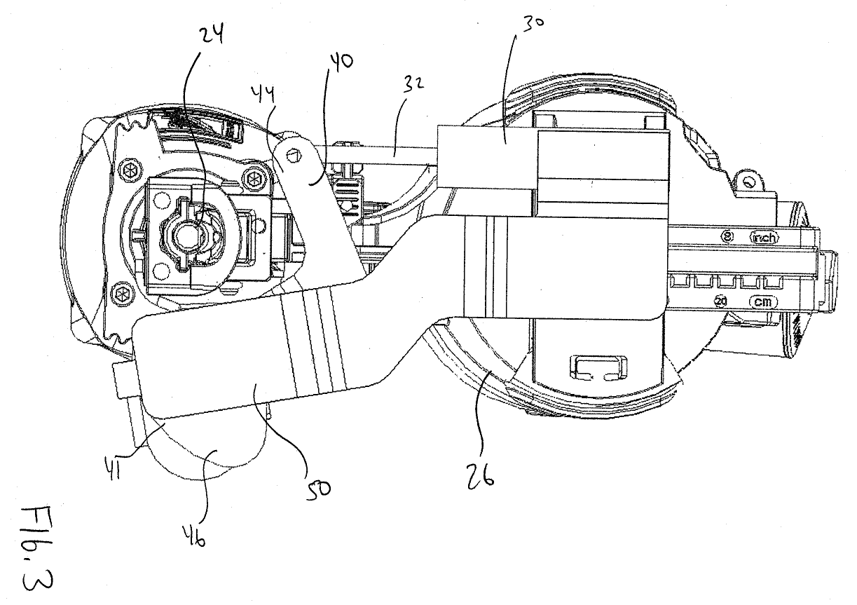

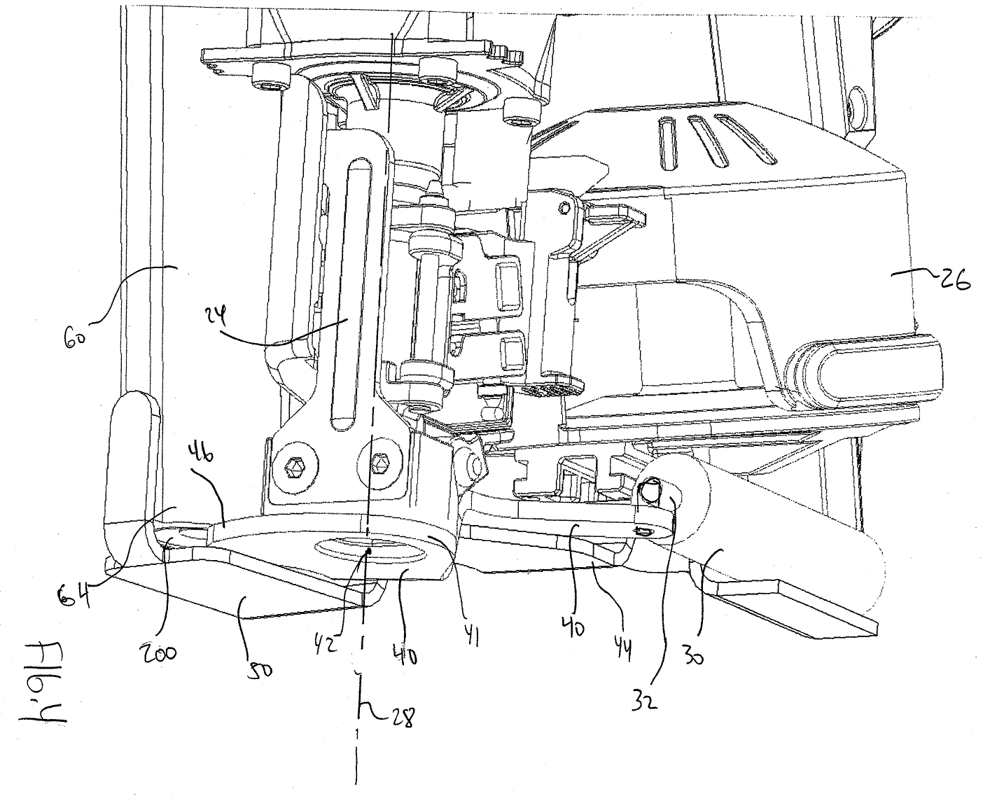

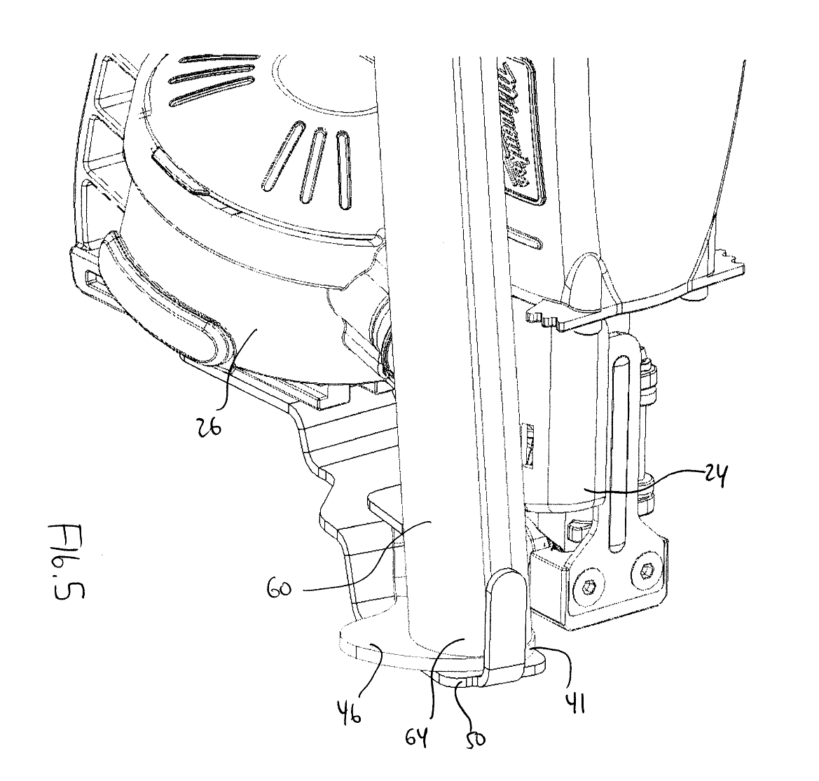

As shown in FIGS. 1-5 and 14-15, the shuttle 40 reciprocates to transfer a fastener cap 200 from the stack provided within the cap magazine 60 to below, or in proximity to the power nailer 24 for receiving a nail expelled by the power nailer 24. The shuttle 40 includes a first end 44 that is operatively engaged with an extended end of a shaft 32 that translates within an air piston 30, and a second end 41 that reciprocates between a position in proximity to the power nailer 24 and the nail axis 28 (FIGS. 2 and 4) and a second position in proximity to the second end 64 of the cap magazine 60 (FIGS. 3 and 5). As is known in the art, exhaust air from the power nailer 24 may flow through an air piston 30 to cause the shaft 32 to reciprocate.

The air piston 30 includes a shaft 32 that may reciprocate longitudinally through the air piston 30 against the biasing force of an internal spring (not shown). The internal spring biases the shaft 32 to the first position where the shaft 32 is substantially within the air piston 30 and the second end 41 is in proximity with the output of the power nailer 24. When the exhaust compressed air enters the air piston 30, the air acts on the shaft 32 to propel the shaft 32 toward the front end (i.e. the side with the power nailer 24) of the cap nailer/stapler 10 against the biasing force of the spring.

shuttle 40 is rotatably mounted to the housing 12 on a pivot point 34 such that the linear motion of the shaft 32 is transferred to reciprocating curved motion of the second end 41 of the shuttle 40. The second end 41 of the shuttle 40 includes a cap aperture 42, which has a diameter that is slightly smaller than the diameter of the fastener caps 200 used with the cap nailer/stapler 10. As shown in FIG, 15, the shuttle 40 may include a round valley 48 that is coaxial with the fastener cap 200 and has a diameter slightly larger than the diameter of the fastener caps 200 used with the cap nailer/stapler 10. As the shuttle 40 translates to and reaches the second position, the bottom most fastener cap 200 slides through the cap magazine 60 and onto the shuttle 40. The fastener cap 200 may be held on the moving shuttle 40 by the cap resting within the valley 48. After receiving a fastener cap 200 from the cap magazine 60, the shuttle 40 translates to the first position below the power nailer 24 and substantially in-line with the nail axis 28, the compressed air within the air piston 30 eventually bleeds off, allowing the internal biasing spring to translate the shaft 32 away from the front end of the cap nailer/stapler 10.

As is known in the art, a charge of compressed air flows from the air inlet 22 to the power nailer 24 when the user presses the trigger 23 of the cap nailer and a nail, stapler, brad, or similar fastener, is expelled from the power nailer 24. Because the nail exits the power nailer 24 with a significant amount of force, the tip and the body of the nail extend through the fastener cap 200 that is held on the shuttle 40. As the nail travels through the fastener cap 200, a portion of the energy within nail is transferred to the fastener cap 200, which causes the fastener cap 200 to elastically deform because the center of the fastener cap 200 is pressed downward by the nail with the outer edge being retained by the periphery of the cap aperture 42.

Eventually, the fastener cap 200 deforms enough to cause the diameter of the downward projection of the fastener cap 200 to be smaller than the diameter of the cap aperture 42, allowing the fastener cap 200 to move through the cap aperture 42 and contact the work surface along with the nail. As discussed above, as the compressed air drives the power nailer 24, the air flows to the air piston 30 causing the shuttle 40 to reciprocate to the cap magazine 60 to obtain a new fastener cap 200 for use when the trigger 23 is pressed again.

In the embodiments shown in FIGS. 1-5 and 14-15, the shuttle 40 includes a wing 46 that extends from the second end 41 of the shuttle 40. The wing 46 is formed to selectively cover a portion of the second end 64 of the cap magazine 60 to prevent fastener caps 200 from falling out of the second end 64 of the cap magazine 60 during operation. Specifically, as best shown in FIGS. 2 and 4, the wing 46 on the shuttle 40 is located beneath a portion of the second end 64 of the cap magazine 60 when the shuttle 40 is located in proximity to the power nailer 24. As the shuttle 40 reciprocates toward and reaches the cap magazine 60, the cap aperture 42 and the valley 48 reach a substantially in-line position with respect to the cap magazine 60, allowing the bottom most fastener cap 200 to leave the cap magazine 60 and rests on the shuttle 40. As the shuttle 40 translates toward and reaches the first position under the power nailer 24, the wing 46 again covers the second end 64 of the cap magazine 60. As shown in FIGS. 3 and 5, the wing 46 extends outside of the periphery of the second end 64 of the cap magazine 60 when the cap aperture 42 on the shuttle 40 is substantially in-line with the second end 64 of the cap magazine 60.

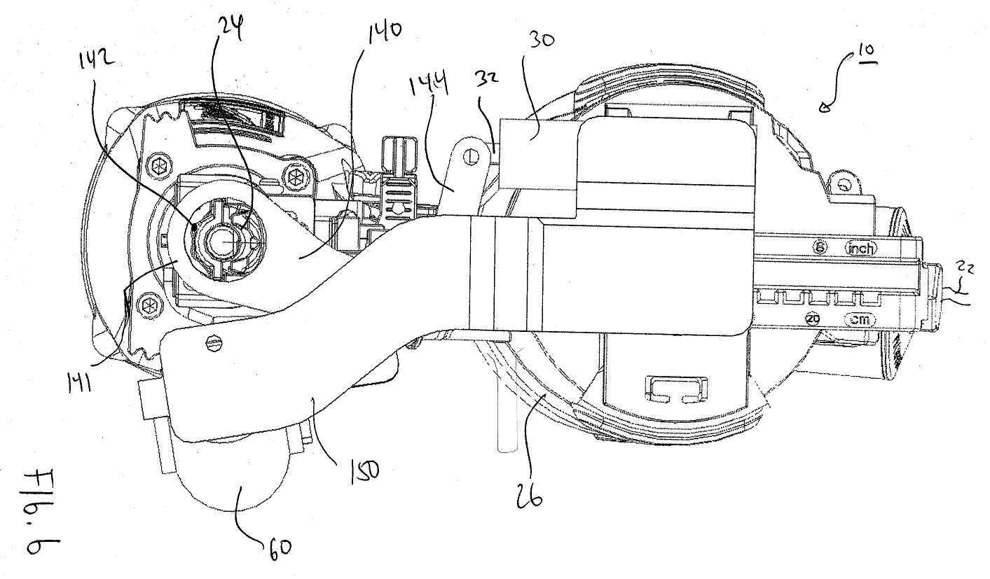

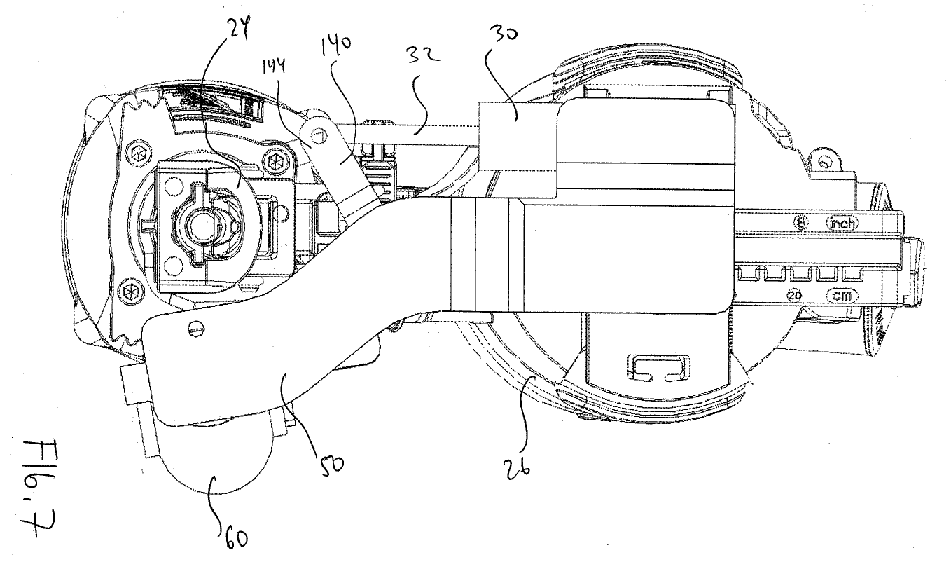

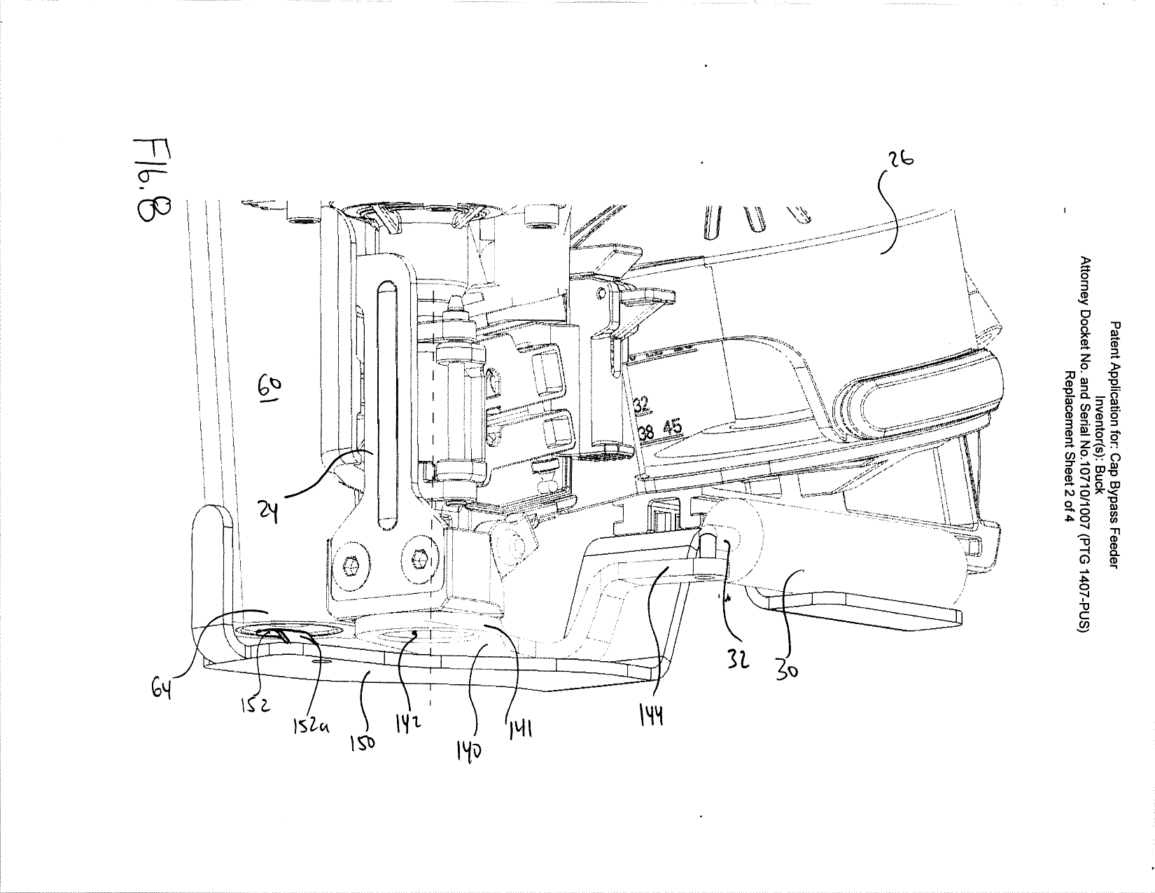

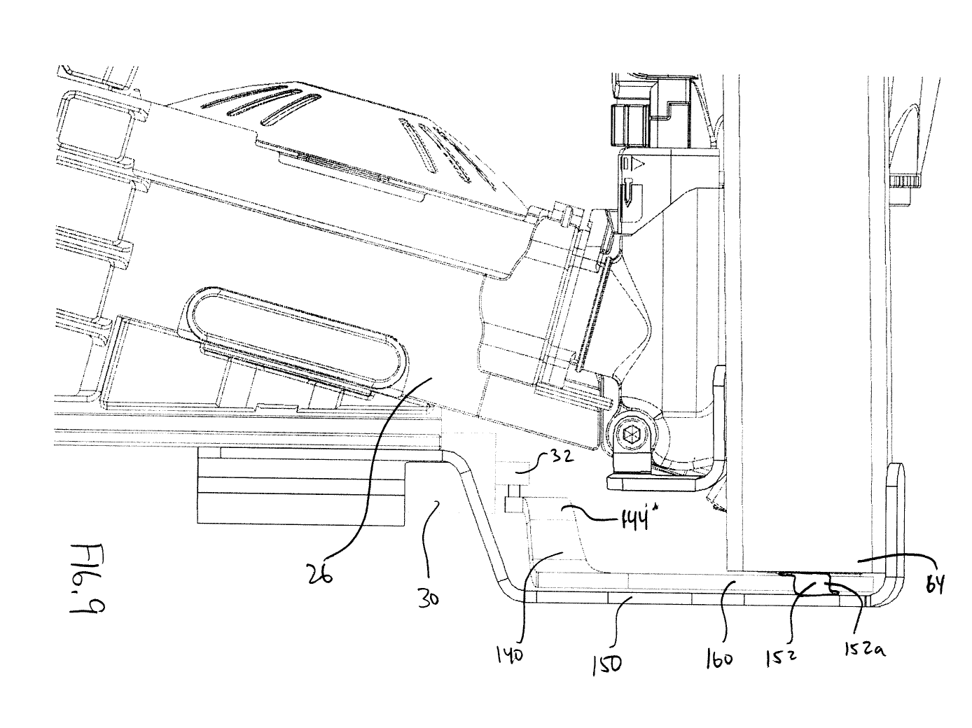

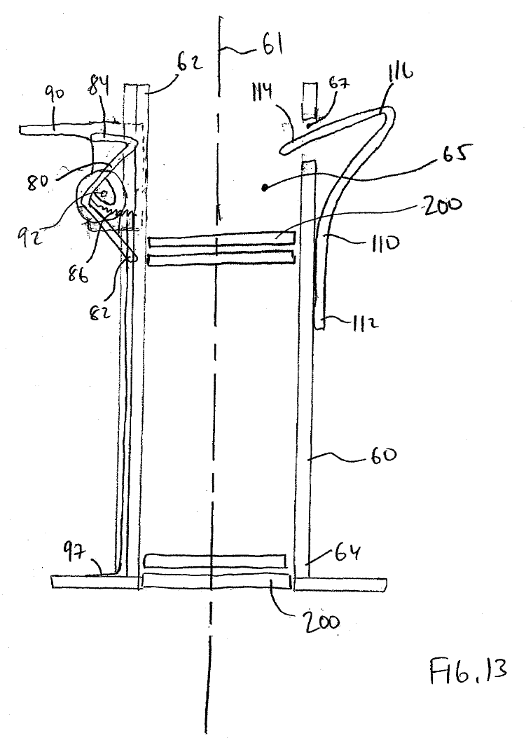

Turning now to FIGS. 6-10, an alternate shuttle 140 is provided. The shuttle 140 includes a first end 144 that is operatively engaged with the shaft 32 of the air piston 30 and is mounted to the housing 12 of the cap nailer/stapler 10 at a pivot point 34. The shuttle 140 includes a second end 141 that reciprocates between first position (FIGS. 6, 8, and 10) where a cap aperture 142 (which includes a round valley 148, similar to the valley 48 discussed above and shown in FIG. 15) is in proximity with the power nailer 24 to a second position (FIGS. 7 and 9) where the cap aperture 142 is in proximity with the second end 64 of the cap magazine 60, based on the movement of the shaft 32 within the air piston 30.

A bracket 150 is connected to the housing 12 of the cap nailer/stapler 10 and extends below the second end 64 of the cap magazine 60. The bracket 150 includes an upwardly extending leaf spring 152 provided between the bracket 150 and the second end 64 of the cap magazine 60 to bias the stack of fastener caps 200 within the cap magazine 60 to a level in-line with the bottom edge of the cap magazine 60. The leaf spring 152 includes an inclined surface 152a that is positioned to be contacted by the shuttle 140 as the shuttle 140 reciprocates from the proximity of the power nailer 24 toward the proximity of the cap magazine 60.

As the leading edge of the shuttle 140 contacts the inclined section 152a of the leaf spring, the shuttle 140 compresses the leaf spring 152 between the bracket 150 and the shuttle 140, allowing the shuttle 140 to pass over the leaf spring 152. Accordingly, when the cap aperture 142 of the shuttle 140 is in the proximity of the second end 64 of the cap magazine 60, the bottom most fastener cap 200 falls to the first end 141 (and within the valley 148) of the shuttle 140 and is reciprocated toward the power nailer 24 as the air pressure within the air piston 30 bleeds away. As the leading edge of the shuttle 140 moves away from the leaf spring 152, the leaf spring 152 expands to again retain the next fastener cap 200 (now the bottom most fastener cap 200) within the cap magazine 60.

Turning now to FIGS. 11-13, the cap magazine 60 may be provided with a rotatable and translatable latch 80 to retain a plurality of fastener caps 200 within the cap magazine 60 regardless of the orientation of the cap nailer/stapler 10. Additionally, the latch 80 provides a downward, or sideward (depending on the orientation of the cap magazine 60) compressive force on the stack of fastener caps 200 within the cap magazine 60 to ensure that the bottom most fastener cap 200 is placed on the shuttle 40 (or 140) when the shuttle 40 (140) translates to the position in the proximity of the second end 64 of the cap magazine 60. The cap magazine 60 discussed herein may be used with a pneumatic device, or with another type of manual or powered device for installing a plurality of fasteners and associated caps into a surface.

The cap magazine 60 includes a track 66 formed by two outwardly extending arms 66a that extend in opposite directions along the same plane. The track 66 may be formed either on the outer cylindrical surface of the cap magazine 60 or within the internal volume 65 of the cap magazine 60. A slot 68 is defined between the arms 66a of the track 66. In the preferred embodiment, each of the track 66 and the slot 68 extend along substantially the entire length of the cap magazine 60 from the first end 62 to the proximity of the second end 64 in parallel to the longitudinal axis 61 of the cap magazine 60.

A bracket 90 is provided with two legs 91 that extend inwardly toward each other along the same plane and are slidingly received within the track 66. The bracket 90 includes a pin 92 that extends through the bracket 90 that rotatably receives a coiled spring 96, with the coils of the spring 96 tightly would around the pin 92. A fixed end 97 of the coil spring 96 is fixed to the cap magazine 60 in proximity to the second end 64. The coil spring 96 operates to bias the bracket 90 toward the second end 64 of the cap magazine along the track 66.

The latch 80 is rotatably connected to the pin 92, such that the latch 80 is rotatable along an axis perpendicular to the longitudinal axis 61 of the cap magazine 60. The latch 80 includes a first portion 82 that is extendable through the slot 68 into the hollow internal volume 65 of the cap magazine 60. The first portion 82 is sized such that when the first portion 82 normally extends into the internal volume, or bore, 65 of the cap magazine 60 a distance preferably approximately equal to one quarter of the internal diameter of the cap magazine 60. In other embodiments, the first portion 82 may extend into the internal volume, or bore, 65 of the cap magazine 60 a length between about one-eighth to about one-half of the inner diameter of the cap magazine 60.

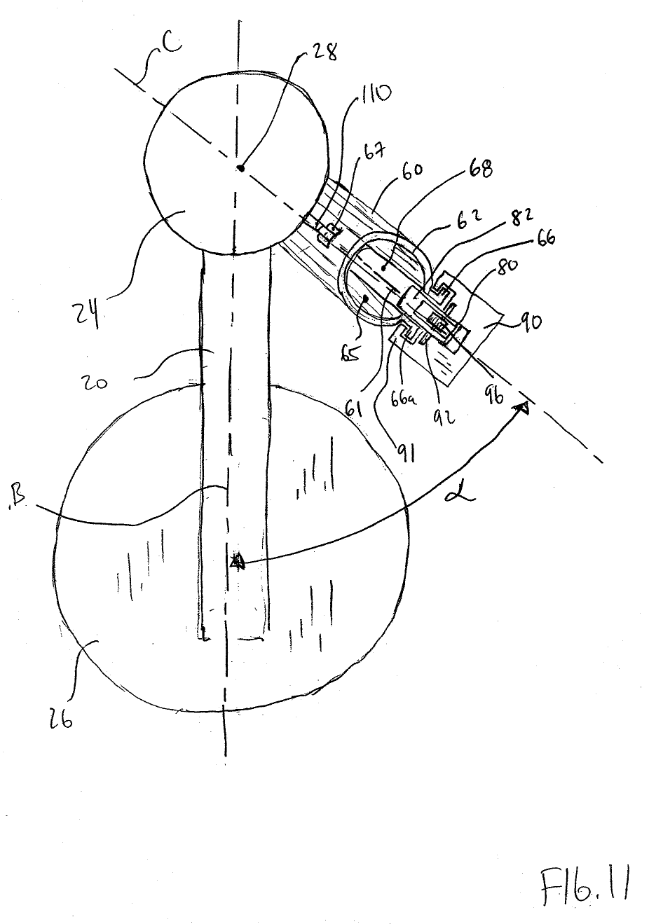

The latch 80 includes a second end, or handle, 84 on the opposite end of the latch 80 from the first portion 82. The second end 84 is biased inward toward the first end 62 of the cap magazine 60 (in the direction X shown in FIG. 12), by a compression spring 86 provided between the latch 80 and the bracket 90. The second end 84 of the latch 80 may be rotated in the direction Y shown in FIG. 12, which correspondingly rotates the first portion 82 of the latch 80. With sufficient rotation in the Y direction, the first portion 82 of the latch 80 no longer extends within the internal volume 65 of the cap magazine 60, as shown in FIG. 13. When the latch 80 is in the position shown in FIG. 13, the first portion 82 provides no downward compressive force or retention capability on the caps 36.

In operation, when the first portion 82 is withdrawn from the internal volume 65 additional caps 36 can be inserted into the internal volume 65 of the cap magazine 60. Alternatively, if caps 36 have been inserted above the first portion 82 the latch 80 may be rotated in the Y direction to withdraw the first portion 82 from the internal volume 65 of the cap magazine 60. The latch 80 and bracket 90 can then be lifted upward along the track 66 toward the first end 62 of the cap magazine 60 against the biasing force of the coil spring 86 until the first portion 82 of the latch 80 is above the stack of fastener caps 200. When the second end 84 of the latch 80 is released, the biasing compression spring 86 rotates the latch 80 in the direction X, which causes the first portion 82 to reenter the internal volume 65 of the cap magazine 60.

A backstop or finger 110 may also be provided on the cap magazine 60. In the embodiment shown in FIGS. 11 -13, the backstop 110 is provided on the opposite side of the cap magazine 60 from the latch 80 and bracket 90, but the backstop 110 may be provided in any position or orientation to perform the function of the backstop 110 while not interfering with the operation of the latch 80. The backstop 110 may be a leaf spring. The backstop 110 includes a first end, finger, or retained end, 112 that is fixed to an outer surface of the cap magazine 60. A second end or extended end 114 is biased to extend within the internal volume 65 of the cap magazine 60 through a side aperture 67. The backstop 110 is provided such that the extended end 114 extends into the internal volume 65 sufficiently to prevent fastener caps 200 within the cap magazine 60 below the backstop 110 from falling out of the cap magazine 60 regardless of the orientation of the cap nailer/stapler 10. The backstop 110 additionally includes an operator 116 between the first and second ends 112, 114 of the backstop 110, which provides a portion for the operator to manipulate to withdraw the extended end 114 from the inner volume 65 of cap magazine 60.

In operation, when additional fastener caps 200 are inserted into the cap magazine 60 above the second end 114 of the backstop 110, the weight of the stack of fastener caps 200 presses the second end 114 downward until the second end 114 moves into the side aperture 67 of the cap magazine 60, allowing the stack of fastener caps 200 to be completely inserted into the cap magazine 60. If the stack of fastener caps 200 below the second end of the backstop 110 need to be removed, the user may manipulate the operator 116 to pull the extended end 114 out of the internal volume 65 through the side aperture 67 to provide clearance to remove the stack of fastener caps 200. After the operator 116 is released, the extended end 114 of the backstop reextends within the inner volume 65 of the cap magazine 60 due to the internal biasing force of the backstop 110.

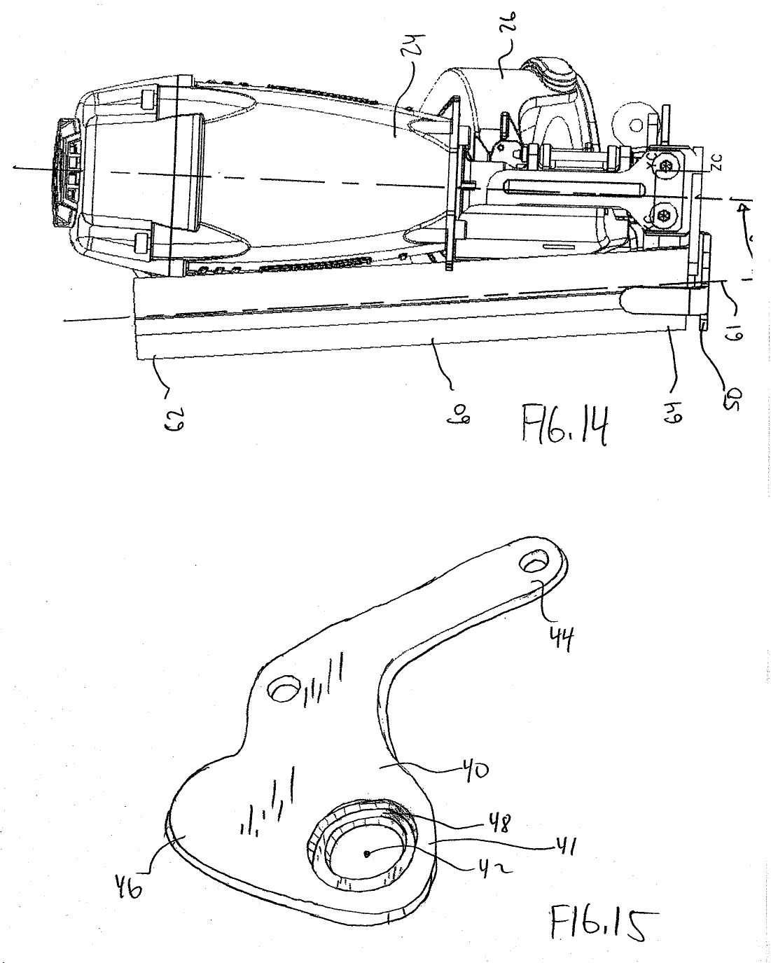

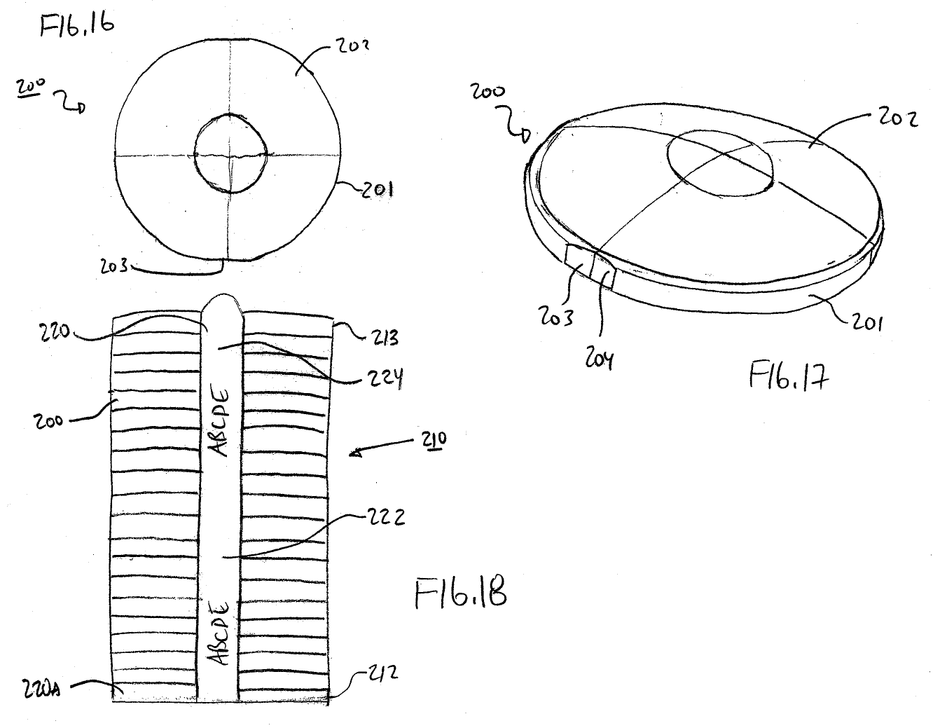

Turning now to FIGS. 16-17, a fastener cap 200 for use with a driver such as a pneumatic nailer/stapler 10 (FIG. 1), or another manual or powered device for applying a plurality of fasteners with corresponding fastener caps 200 into a material, is shown. The fastener cap 200 typically is used to securely fasten a sheetlike material such as roofing felt, sheathing, house wrap or the like to a substrate such as wood, particle board, or insulation board. To attach the sheet material to the substrate, a fastener is ejected from the pneumatic nailer/stapler 10, penetrating the fastener cap 200 and fastening it to the sheet material and substrate beneath it.

The fastener cap 200 preferably is made out of plastic or metal such as galvanized steel, stainless steel, or any resilient metal suitable for exposure to inclement weather. The fastener cap 200 has a generally disc-like, circular shape that includes an outer peripheral wall 201 and a top surface 202. Preferably, at least one flat surface 203 is formed or manufactured into a portion 204 of the outer peripheral wall 201. While a preferred embodiment contemplates a fastener cap 200 having a circular shape, in alternate embodiments the fastener cap 200 may have other shapes so long as it can be attached to the sheet material and substrate.

To use the fastener cap 200 with the pneumatic nailer/stapler 10, and as shown in FIG. 18, a plurality of fastener caps 200 are placed atop each other to form a stack 210 having a proximal and distal end 212, 213. The fastener caps 200 forming the stack 210 and are collated so that the flat surfaces 202 of the fastener caps 200 are in alignment. Once the flat surfaces 202 are aligned, an adhering strip 220 may be attached to the flat surfaces 202 along the length of the stack 210 so that the fastener caps 200 remain atop each other. The flat surface 203 is preferred because it enables the adhering strip 220 to be more easily applied to the stack 210.

The adhering strip 220 may be made of a polyester tape such as MYLAR, a thin paper with an adhesive backing, or a cured adhesive. In an alternate embodiment, the adhering strip 220 may instead be an adhesive outer wrapper that surrounds the entire circumference of the stack 210. In yet other embodiments, the outer wrapper may be made of a non-adhesive paper such as cellophane or shrink wrap that is fixed to the stack 210 of fastening caps 200. Optionally, the adhering strip 220 (or outer wrapper) may also act as a surface 222 that contains lettering such as, by way of example, advertising, branding or instructions. In an alternate embodiment, the adhering strip 220 may instead be an adhering outer wrap that surrounds the entire circumference of the stack 210.

Once the stack 210 is formed, it may be loaded into a cap magazine 60 (FIG. 12) of the pneumatic nailer/stapler 10 in order to be dispensed. The stack 210 is placed within a bore, or internal cavity, 65 of the cap magazine 60. A backstop 110 associated with the cap magazine 60 will retain the stack 210 within the bore 65. Prior to the fastener cap 200 being dispensed from the cap magazine 60, the adhering strip 220 is sheared so that the fastener cap 200 to be dispensed is separated from the stack 210. With reference to FIG. 3, the fastening cap 200A would be dispensed above the outer peripheral wall 201. A fastener such as a nail or staple (not shown) is then driven through the top surface 202 of the fastener cap 200 so that the fastener cap 200 fastens the sheet material to the substrate beneath.

Once the stack 210 has been depleted, another stack 210 may be loaded within the cap magazine 60. A portion 224 of the adhering strip 220 coextensive with the distal end 213 of the stack 210 may be colored or otherwise marked so as to contrast with the remainder of the adhering strip 200 in order to indicate that the stack 210 is nearing depletion.

The advantages associated with the collation of the fastener caps 200 are numerous. In prior-art collations, caps are often kept together in a stack through the use of a retaining cord such as a mandrill or string that extends through a hole in the center of each fastening caps. Once the caps are loaded into the magazine, the retaining cord must be removed so that the caps may be dispensed. When the retaining cord is removed, the caps my have a tendency to flip over, requiring that time be used rearranging the caps so that they do not jam the pneumatic nailer/stapler. Moreover, the retaining cord, upon its removal, also creates extra waste around a worksite. In contrast, the adhering strip (or outer wrapper) remains affixed to the fastener cap.

The use of the adhering strip (or outer wrap) 220 also simplifies the loading process, as no retaining string needs to be removed from the stack 210—the stack 210 simply is placed within the magazine. Moreover, collated caps also simplify the loading process as compared to fastener caps that are assembled in a coiled, side-by-side configuration, which must be threaded from the magazine into a feeding mechanism.

The present collation of fastener caps 200 eliminates the “wasting” of caps. If a stack 210 breaks in “partial stacks” these stack 210 may easily be loaded into the cap magazine 60. In contrast, if a coil of caps tears, the coil may have to be removed, reloaded and/or rethreaded. Moreover, smaller portions of a coil may have to be discarded, thus wasting caps.

Finally, although the collated stack 210 may be made of fastener caps 200 each having a hole in their center, preferably the top surface 202 of the fastener 202 will be continuous. The absence of a hole in the center of the top surface 202 will increase the ability of the fastener cap 200 to seal out water after being fastened to the sheet material and substrate, in addition to allowing a nail or other type of fastener to be inserted through the center of the fastener cap 200.

The foregoing disclosure is the best mode devised by the inventors for practicing this disclosure. It is apparent, however, that apparatus incorporating modifications and variations will be obvious to one skilled in the art. Inasmuch as the foregoing disclosure is intended to enable one skilled in the pertinent art to practice the instant disclosure, it should not be construed to be limited thereby but should be construed to include aforementioned obvious variations and be limited only by the spirit and scope of the following claims.

It is therefore intended that the foregoing detailed description be regarded as illustrative rather than limiting, and that it be understood that it is the following claims, including all equivalents, that are intended to define the spirit and scope of this disclosure.

1. A pneumatic nailing mechanism comprising:
(a) a housing;
(b) a nail driving mechanism provided on the housing for driving a nail from a nail magazine; and
(c) a cap magazine with a first end and a second end, the cap magazine extending from the housing and including an axis through the center of the cap magazine, wherein the cap magazine comprises:
i. a track and a slot defined along the track that extend from the proximity of the first end to the proximity of the second end of the cap magazine;
ii. a rotatable latch member with a first portion extendable through the slot into an internal volume of the cap magazine and a second portion extending radially out of the cap magazine; and
iii. a bracket with at least one leg configured to ride within the track to allow the bracket to translate with respect to the cap magazine along the track, wherein the latch member is rotatably connected to the bracket.

2. The pneumatic nailing mechanism of claim 1, wherein the latch member is rotatably connected to the bracket along an axis perpendicular to the cap magazine.

3. The pneumatic nailing mechanism of claim 1, further comprising a coil spring with a first end fixed to the second end of the cap magazine and a second end fixed to the bracket.

4. The pneumatic nailing mechanism of claim 1, further comprising a feed mechanism to translate a cap from the cap magazine to below the nail driving mechanism for receiving the nail driven by the nail driving mechanism.

5. The pneumatic nailing mechanism of claim 1, wherein a plurality of caps may be received within the internal volume of the cap magazine, wherein an outer diameter of the plurality of caps is slightly smaller than an inner diameter of the cap magazine.

6. The pneumatic nailing mechanism of claim 1, wherein the first portion of the latch member covers a portion of the cap received within the cap magazine when the latch member is in a first position, and when the latch member is rotated to a second position the first portion is withdrawn from the internal volume of the magazine.

7. The pneumatic nailing mechanism of claim 1, further comprising a spring biasing the latch member into the first position.

8. The pneumatic nailing mechanism of claim 1, further comprising a finger extendable into the internal volume in the cap magazine.

9. The pneumatic nailing mechanism of claim 8, wherein the finger extends into the internal volume of the cap magazine through an aperture in the side surface of the cap magazine.

10. The pneumatic nailing mechanism of claim 8, wherein the finger is a leaf spring.

11. The pneumatic nailing mechanism of claim 8, wherein a first end of the finger is extendable into the internal volume of the cap magazine and a second end of the finger is fixed to the outer cylindrical surface of the cap magazine.

12. The pneumatic nailing mechanism of claim 11, wherein the finger further comprises an operator between the first and second ends to allow the first end to be withdrawn from the internal volume of the cap magazine.

13. A pneumatic nailing mechanism comprising:
(a) a housing;
(b) a driving mechanism provided on the housing for driving a fastener from a magazine;
(c) a cap magazine extending from the housing comprising:
i. a longitudinal axis between a first end and a second end;
ii. a track and a slot defined within the track in parallel to the longitudinal axis from the proximity of the first end to the proximity of the second end of the cap magazine;
iii. a latch member; and
iv. a bracket configured to ride within the track and translate with respect to the cap magazine, wherein the latch member is rotatably connected to the bracket; and
(d) a finger capable of retaining a cap within the internal volume of the cap magazine.

14. The pneumatic nailing mechanism of claim 13, wherein the latch member includes a first portion that is extendable through the slot into the internal volume of the cap magazine to engage the cap within the cap magazine and a second portion that extends radially out of the cap magazine.

15. The pneumatic nailing mechanism of claim 13, wherein the latch member is rotatably connected to the bracket along an axis perpendicular to the cap magazine axis.

16. The pneumatic nailing mechanism of claim 13, further comprising a coil spring with a first end fixed to the second end of the cap magazine and a second end fixed to the bracket.

17. The pneumatic nailing mechanism of claim 13, further comprising a shuttle configured to translate a cap from the second end of the cap magazine to below the driving mechanism

18. The pneumatic nailing mechanism of claim 13, wherein the finger extends into the internal volume of the cap magazine through an aperture in the side of the cap magazine.

19. The pneumatic nailing mechanism of claim 13, wherein the finger comprises a first end that is extendable into the internal volume of the cap magazine and a second end of the finger is fixed to the outer cylindrical surface of the cap magazine.

20. The pneumatic nailing mechanism of claim 19, wherein the finger further comprises an operation between the first and second ends to allow the first end to be withdrawn from the internal volume of the cap magazine.
